(19) United States
(12) Patent Application Publication
(10) Pub. No.: US 2025/0243119 A1
(43) Pub. Date: Jul. 31, 2025

(54) SINTERED CALCIUM CARBONATE-RICH COASTAL SAND COMPOSITION AND PREPARATION METHOD THEREOF

(71) Applicant: KING FAHD UNIVERSITY OF PETROLEUM AND MINERALS, Dhahran (SA)

(72) Inventors: Omar Atef RADWAN, Dhahran (SA); Mohamed Abdrabou HUSSEIN, Dhahran (SA); John Dean HUMPHREY, Dhahran (SA); Ammar Mohammed AL-RAMADHAN, Dhahran (SA)

(73) Assignee: KING FAHD UNIVERSITY OF PETROLEUM AND MINERALS, Dhahran (SA)

(21) Appl. No.: 18/598,731

(22) Filed: Mar. 7, 2024

(30) Foreign Application Priority Data
Jan. 29, 2024 (SA) 1020240418

(51) Int. Cl. C04B 35/03; C04B 35/14; C04B 35/626; C04B 35/645

(52) U.S. Cl. CPC C04B 35/03; C04B 35/14; C04B 35/6261; C04B 35/62655; C04B 35/62675; C04B 35/645; C04B 2235/3418; C04B 2235/442; C04B 2235/5436; C04B 2235/5445; C04B 2235/6021; C04B 2235/604; C04B 2235/656; C04B 2235/96

(57) ABSTRACT

A sand composition includes a carbonate sand present in an amount of 50 to 99.99% by weight, and a quartz sand in an amount of 0.01 to 50% by weight, each % based on a total weight of the sand composition. A cured specimen made from the sand composition has a compressive strength of 10 to 40 megapascal (MPa), and the compressive strength of the cured specimen is 10 to 90% greater than the compressive strength of a cured specimen made from a class G cement slurry.

### CROSS REFERENCE TO RELATED APPLICATION

The present disclosure claims the benefit of Saudi Patent Application No. 1020240418 filed on Jan. 29, 2024, with the Saudi Authority for Intellectual Property Office, which is incorporated herein by reference in its entirety.

### BACKGROUND

### Technical Field

The present disclosure is directed to a sand composition, particularly to a sand composition containing carbonate sand and quartz sand, cured composition obtained by sintering the sand composition, a method of preparation thereof and method of forming a cured sand composition.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Sand serves as a raw material in the production of concrete and mortar. When mixed with other materials like coarse aggregates, hydraulic binders, and water, it yields commonly used construction materials. Sand is classified by shape, ranging from elongate and sharp-edged to nearly spherical and smooth. Medium to coarse sand, such as river shore sand and/or coastal sand, having a rough surface and a sharp corner shape is applied in making concrete.

The formation of sand is a result of rock weathering. Based on the natural sources from which sand is obtained, it may be classified as Pit sand, River sand, and Sea sand. Sand composition encompasses various types, including but not limited to quartz sand (silica), calcium carbonate, calcium sulfate (gypsum sand), dune sand, and coral sand. However, there is a global shortage of sand for construction, causing environmental damage and illegal exploitation of natural resources.

On the other hand, coastal and desert sands may exhibit elevated levels of calcium carbonate. These sands, rich in carbonate, are abundant and easily accessible. Existing cement technology may efficiently process coastal and desert sands, offering a viable solution amid the global sand shortage.

CN111995331A discloses a calcium carbonate sand reinforced cement material. The material contains portland cement, fly ash, expanding agent, and the calcium carbonate sand obtained from the South China Sea islands. Additionally, the South China Sea islands sand has an average particle size of 75 to 250 micrometers (μm). However, CN111995331A does not describe the carbonate sand obtained from the Red Sea coast is in the form of irregular shaped calcium carbonate particles with an average particle size D₅₀ of about 3.6 μm.

WO2023105437A1 discloses a method for reducing the amount of silica in a sand composition. However, WO2023105437A1 does not describe a sand composition containing a carbonate sand with an average particle size D₅₀ of about 3.6 μm.

US20200331770A1 discloses a method for producing a calcium carbonate sintered compact. The method includes (i) mixing calcium carbonate and a sintering aid to form a compact, and (ii) sintering the compact at a temperature of 380 to 600° C. However, US20200331770A1 does not describe a sand composition containing a carbonate sand with an average particle size D₅₀ of about 3.6 μm. Additionally, the method of the present disclosure does not require sintering a compact at a temperature of 380 to 600° C.

US11161787B2 discloses a method for producing a calcium carbonate sintered compact. The method includes (i) mixing calcium carbonate particles having an average particle size D₅₀ of 0.05 to 0.3 μm to form a compact, and (ii) sintering the compact at a temperature of 420 to 600° C. However, US11161787B2 does not describe a sand composition containing a carbonate sand with an average particle size D₅₀ of about 3.6 μm. Additionally, the method of the present disclosure does not require sintering a compact at a temperature of 420 to 600° C.

Bradley, et. al. (Earth Surf. Process., 2018) discloses a Saudi Arabia desert sand containing medium-to fine-quartz sands. However, Bradley does not describe a sand composition containing a carbonate sand having an average particle size D50 of about 3.6 μm.

Garzanti et al. (Earth Sci Rev., 2013) discloses an Arabian coastal dune sand containing carbonate rocks. However, Garzanti does not describe a sand composition containing a carbonate sand with an average particle size D₅₀ of about 3.6 μm.

Radwan et al. (Sol. Energy Mater., 2021) discloses an Arabian desert sand containing ≥99% quartz. However, Radwan does not describe a sand composition containing a carbonate sand with an average particle size D₅₀ of about 3.6 μm.

The drawbacks of each of the compositions and methods described above indicate that there is still a need for producing construction materials for coastal structures from sustainable calcium carbonate-rich coastal sands. More importantly, the challenge is that such compositions and methods should be cost-effective and rapid to attract industries to adopt these processes.

In view of the foregoing, one objective of the present disclosure is to provide a composition using sustainable and cost-effective coastal sands that are rich in calcium carbonate. The composition after curing may serve as a construction material for coastal structures. A second objective of the present disclosure is to provide a method of making a cured specimen containing the sand composition.

### SUMMARY

In an exemplary embodiment, a sand composition is described. The sand composition includes a carbonate sand present in an amount of 50 to 99.99 percent (%) by weight based on a total weight of the sand composition. The sand composition further includes a quartz sand in an amount of 0.01 to 50% by weight based on the total weight of the sand composition. A cured specimen made from the sand composition has a compressive strength of 10 to 40 megapascal (MPa). In some embodiments, the compressive strength of the cured specimen is 10 to 90% greater than the compressive strength of a cured specimen made from a class G cement slurry.

In some embodiments, the carbonate sand is present in an amount of 50 to 90% by weight based on the total weight of the sand composition. In some embodiments, the quartz sand is present in an amount of 10 to 50% by weight based on the total weight of the sand composition. In some embodiments, the cured specimen made from the sand composition has a compressive strength of 25 to 35 megapascal (MPa). In some embodiments, the compressive strength of the cured specimen is 50 to 90% greater than the compressive strength of the cured specimen made from the class G cement slurry.

In some embodiments, the carbonate sand is obtained from the Red Sea coast.

In some embodiments, the carbonate sand is in the form of irregularly shaped calcium carbonate particles having a cumulative 10% particle size (D₁₀) of about 0.9 micrometers (μm).

In some embodiments, the carbonate sand is in the form of irregularly shaped calcium carbonate particles having a median particle size (D₅₀) of about 3.6 μm.

In some embodiments, the carbonate sand is in the form of irregularly shaped calcium carbonate particles having a cumulative 90% particle size (D₉₀) of about 26 μm.

In some embodiments, the quartz sand is obtained from the Nafud desert.

In some embodiments, the quartz sand is in the form of irregularly shaped silica particles having a D₁₀ particle size of about 1.4 μm.

In some embodiments, the quartz sand is in the form of irregularly shaped silica particles having a D₅₀ particle size of about 9.3 μm.

In some embodiments, the quartz sand is in the form of irregularly shaped silica particles having a D₉₀ particle size of about 30.7 μm.

In some embodiments, the carbonate sand includes calcium carbonate. The calcium carbonate includes aragonite polymorph and calcite polymorph.

In some embodiments, a ratio of the aragonite polymorph and the calcite polymorph is in a range of 3:2 to 4:1.

In another exemplary embodiment, a method of making a cured specimen is described. The method includes grinding the carbonate sand and the quartz sand to form a powder mixture. The method includes mixing the powder mixture and an aqueous solution to form a slurry. The method includes introducing the slurry into a die to form a sample, and sintering the sample at room temperature under a uniaxial pressure to form a sintered sample. In some embodiments, a ratio of aragonite, calcite, and quartz remains unchanged after sintering the sample. The method further includes drying the sintered sample to form the cured specimen.

In some embodiments, the carbonate sand after grinding has a D₅₀ particle size of about 3.6 μm. In some embodiments, the quartz after grinding has a D₅₀ particle size of about 9.3 μm.

In some embodiments, the aqueous solution includes at least one inorganic salt selected from the group consisting of a sodium salt, a potassium salt, a calcium salt, a magnesium salt, a lithium salt, and an aluminum salt. In some embodiments, the at least one inorganic salt includes a halogen counterion.

In some embodiments, the at least one inorganic salt is present in the aqueous solution at a concentration of 0.5 to 2 wt. % based on a total weight of the aqueous solution.

In some embodiments, a weight ratio of the powder mixture and the aqueous solution is about 5:1.

In some embodiments, the method includes sintering the sample under the uniaxial pressure of 200 to 400 MPa for 10 to 60 minutes.

In some embodiments, the method includes drying the sintered sample at a temperature of 60 to 100 degrees Celsius (° C.) for 1 to 12 hours.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of making a cured specimen from a sand composition of the present disclosure, according to certain embodiments;

FIG. 2 shows particle size distribution of raw materials (Red Sea powder and quartz powder) used for cold-sintering, according to certain embodiments;

FIG. 3 shows powder X-ray diffraction (PXRD) patterns of the Red Sea sand, quartz sand, cold-sintered Red Sea powder (R100), and cold-sintered Red Sea powder (70%) mixed with quartz powder (30%) (R70), according to certain embodiments;

FIG. 4A shows a photomicrograph of the Red Sea beach sand taken under a stereomicroscope, according to certain embodiments;

FIG. 4B shows a photomicrograph of the Red Sea beach sands taken under a polarizing microscope (scale bar in each graph is 100 μm), according to certain embodiments;

FIG. 4C shows a scanning electron microscopic (SEM) photomicrograph of cold-sintered Red Sea powder, according to certain embodiments;

FIG. 4D shows an SEM photomicrograph of cold-sintered Red Sea powder (50%) mixed with quartz powder (50%), according to certain embodiments; and

FIG. 5 shows a plot of compressive strength results of cold-sintered Red Sea carbonate powder before and after being mixed with varying amounts of quartz powder, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, the term “sand” refers to a combination of tiny and fine particles made up of different materials, minerals, and rocks. Sand is defined by its grain size, although it can have various compositions.

As used herein, the term “compressive strength” generally refers to the ability of a material to withstand axial loads or forces that tend to squeeze or crush it. Compressive strength is one of the mechanical properties used to assess the resistance of a material to compression. In the present disclosure, the term “compressive strength” may be measured by applying a compressive force to a cured specimen prepared from a sand composition until it fails or undergoes deformation.

As used herein, “particle size” may be thought of as the length or longest dimension of a particle.

As used herein, the term “sintering” generally refers to a process of compacting and forming material into a solid mass, using pressure and heat without melting it into a liquid state.

As used herein, the term “cement” generally refers to a composition or substance with one or more constituents that is capable of binding materials together. The term includes reference to a dry, pre-set composition unless the context clearly dictates otherwise.

A weight percent of a component, unless specifically stated to the contrary, is based on the total weight of the formulation or composition in which the component is included. For example, if a particular element or component in a composition or article is said to have 5 wt %, it is understood that this percentage is in relation to a total compositional percentage of 100%.

Aspects of the present disclosure are directed to a sand composition served as construction material for coastal structures. The sand composition contains a sustainable and cost-effective calcium carbonate-rich coastal sand. The carbonate sand sample used in the present disclosure may be collected from a beach on the central Saudi Arabian side of the Red Sea. Additionally, the sand composition further contains a quartz sand originated from the Nafud desert, in the northern region of the Arabian Peninsula.

According to the first aspect, the present disclosure relates to a sand composition. In some embodiments, the sand composition contains at least one type of sand including but not limited to, quartz sand (silica), calcium carbonate, calcium sulfate (gypsum sand), dune sand, and coral sand. In a preferred embodiment, the sand composition includes carbonate sand and low quartz content. Carbonate sands may be found in coral reefs and seashores throughout the South China Sea, Red Sea, West Australian Continental Platform, and Bass Strait. In a preferred embodiment, the carbonate sand is obtained from the Red Sea coast. Quartz sand is mostly found on passive continental margins' coasts, Great Nafud, and Rub al-Khali Sand Seas. Siesta Key Beach sand in Florida is almost entirely composed of quartz grains. In a preferred embodiment, the quartz sand may be obtained from the Nafud desert.

In an embodiment, the sand composition includes carbonate sand present in an amount of 50-99.99%, by weight based on a total weight of the sand composition, preferably 51-99%, preferably 52-98%, preferably 53-97%, preferably 54-96%, preferably 55-95%, preferably 56-94%, preferably 57-93%, preferably 58-92%, preferably 59-91%, preferably 60-90%, preferably 61-89%, preferably 62-88%, preferably 63-87%, preferably 64-86%, preferably 65-85%, preferably 66-84%, preferably 67-83%, preferably 68-82%, preferably 69-81%, preferably 70-80%, preferably 71-79%, preferably 72-78%, preferably 73-77%, and preferably 74-76% by weight based on the total weight of the sand composition. Other ranges are also possible.

In a preferred embodiment, the sand composition includes carbonate sand present in an amount of 50-90% by weight based on the total weight of the sand composition, preferably 51-89%, preferably 52-88%, preferably 53-87%, preferably 54-86%, preferably 55-85%, preferably 56-84%, preferably 57-83%, preferably 58-82%, preferably 59-81%, preferably 60-80%, preferably 61-79%, preferably 62-78%, preferably 63-77%, preferably 64-76%, preferably 65-75%, preferably 66-74%, preferably 67-73%, preferably 68-72%, preferably 69-71%, by weight based on the total weight of the sand composition. Other ranges are also possible.

In an embodiment, the sand composition includes quartz sand present in an amount of 0.01-50%, preferably 1-45%, preferably 5-40%, preferably 10-35%, preferably 15-30%, preferably 20-25% by weight based on the total weight of the sand composition. Other ranges are also possible.

In a preferred embodiment, the quartz sand is present in an amount of 10-50% by weight based on the total weight of the sand composition, preferably 11-49%, preferably 12-48%, preferably 13-47%, preferably 14-46%, preferably 15-45%, preferably 16-44%, preferably 17-43%, preferably 18-42%, preferably 19-41%, preferably 20-40%, preferably 21-39%, preferably 22-38%, preferably 23-37%, preferably 24-36%, preferably 25-35%, preferably 26-34%, preferably 27-33%, preferably 28-32%, and preferably 29-31%, by weight based on the total weight of the sand composition. Other ranges are also possible.

In some embodiments, the sand composition may optionally include a curable component in an amount of 1 to 10 wt. % based on a total weight of the sand composition. The curable component includes a cementitious material. In an embodiment, the cementitious material is at least one selected from the group consisting of ordinary portland cement (OPC), pozzolan cement, gypsum cement, aluminous cement, silica cement, and alkaline cement. In some embodiments, the cementitious material is OPC. The OPC is selected from the group consisting of type I, type II, type III, type, IV, type V, type Ia, IIa, IIIa, or a combination of any two or more types of OPC. In a specific embodiment, the cementitious material is the type I ordinary Portland cement (OPC), and the OPC has a standard specification of ASTM C150 (Standard Specification for Portland Cement, ASTM C150, which is incorporated herein by reference in its entirety).

As used herein, the term “ordinary portland cement” generally refers to the most common type of cement in general use developed from types of hydraulic lime and usually originating from limestone. It is a fine powder produced by heating materials in a kiln to form what is called clinker, grinding the clinker, and adding small amounts of other materials. The Portland cement is made by heating limestone (calcium carbonate) with other materials (such as clay) to >1400° C. This process in a kiln is also known as calcination, whereby a molecule of carbon dioxide is liberated from the calcium carbonate to form calcium oxide, or quicklime, which is then blended with the other materials that have been included in the mix to from calcium silicates and other cementitious compounds. The resulting hard substance, called “clinker” is then ground with a small amount of gypsum into a powder to make ordinary Portland cement (OPC). Several types of Portland cement are available with the most common being called ordinary Portland cement (OPC) which is grey in color.

Suitable examples of cementitious materials include hydraulic cements, Saudi Class G hydraulic cement, non-hydraulic cements, Portland fly ash cement, Portland Pozzolan cement, Portland silica fume cement, masonry cement, EMC cement, stuccos, plastic cement, expansive cement, white blended cement, Pozzolan-lime cement, slag-lime cement, supersulfated cement, calcium aluminate cement, calcium sulfoaluminate cement, geopolymer cement, Rosendale cement, polymer cement mortar, lime mortar, and/or pozzolana mortar. In some embodiments, silica (SiO₂) may be present in the cement. In one embodiment, the cement comprises a cement blend of two or more types of cement, for example, a blend comprising Portland cement and non-Portland hydraulic cement. In a further embodiment, the cement is in the dry form. The cement may include SiO₂-containing materials including, but not limited to, belite (2CaO.SiO₂), alite (3CaO.SiO₂), celite (3CaO.Al₂O₃), or brownmillerite (4CaO.Al₂O₃.Fe₂O₃).

The sand composition may further optionally include an alkaline component in an amount of 0.01 to 10 wt. %, based on the total weight of the sand composition, preferably 3 to 8 wt. %, or even more preferably 5 to 6 wt. % based on the total weight of the sand composition. Alkali activation generally releases reactive species (e.g., CaO) from the binder, thus increasing the rate of densification and improving the microstructural strength of the binder, which by extension affects the mechanical properties and durability performance of the cured sand composition. The alkali activator may be a mixture of an aqueous solution of a metal hydroxide, preferably an alkali metal hydroxide (e.g., sodium hydroxide, potassium hydroxide, etc.), and a metal silicate, preferably an alkali metal silicate (e.g., sodium silicate, potassium silicate, etc.). In some embodiments, the alkali activator may be an aqueous solution of a metal hydroxide, preferably an alkali metal hydroxide. In preferred embodiments, the alkali activator is an aqueous mixture of sodium hydroxide and sodium silicate. Preferably, the alkali activator consists of sodium hydroxide and sodium silicate in water. In some more preferred embodiments, a weight ratio of NaOH to the Na₂SiO₃ may generally range from 1:1 to 1:4, preferably 1:1.5 to 1:3.5, preferably 1:2 to 1:3, or even more preferably about 1:2.5. Other ranges are also possible.

The sand composition may further optionally include a plasticizer in an amount of 0.001 to 2 wt. % based on the total weight of the sand composition. The plasticizer includes at least one included from the group consisting of a lignosulfonate plasticizer, a polycarboxylate ether plasticizer, a melamine plasticizer, and a naphthalene plasticizer. In some embodiments, the plasticizer is a combination of two or more plasticizers selected from the above group. In some specific embodiments, the plasticizer is a combination of one or more plasticizers included from the above group with an organic non-volatile compound.

As used herein, a “plasticizer” is an additive that increases the plasticity or fluidity of slurry. Plasticizers increase the workability of “fresh” sand composition, allowing it to be placed more easily, with less consolidating effort. A superplasticizer is a plasticizer with fewer deleterious effects. A “superplasticizer” refers a chemical admixture used herein to provide a well- dispersed particle suspension in the wet sand composition. The superplasticizer may be used to prevent particle segregation and to improve the flow characteristics of the wet sand composition. The superplasticizer may be a polycarboxylate, e.g., a polycarboxylate derivative with polyethylene oxide side chains, a polycarboxylate ether (PCE) superplasticizer, such as the commercially available Glenium 51®. Polycarboxylate ether superplasticizers may allow a significant water reduction at a relatively low dosage, thereby providing good particle dispersion in the wet sand slurry. Polycarboxylate ether superplasticizers are composed of a methoxy-polyethylene glycol copolymer (side chain) grafted with methacrylic acid copolymer (main chain). Exemplary superplasticizers that may be used in addition to, or in lieu of a polycarboxylate ether superplasticizer include, but are not limited to, alkyl citrates, sulfonated naphthalene, sulfonated alkene, sulfonated melamine, lignosulfonates, calcium lignosulfonate, naphthalene lignosulfonate, polynaphthalenesulfonates, formaldehyde, sulfonated naphthalene formaldehyde condensate, acetone formaldehyde condensate, polymelaminesulfonates, sulfonated melamine formaldehyde condensate, polycarbonate, other polycarboxylates, other polycarboxylate derivatives comprising polyethylene oxide side chains, and the like and mixtures thereof. In a preferred embodiment, the sand composition has a weight percentage of the plasticizer ranging from 0.1-3.0% relative to the total weight of the sand composition, preferably 0.2-2.5%, preferably 0.5-2.0%, preferably 1.0-1.8%, preferably 1.2-1.6%, or about 1.5% relative to the total weight of the sand composition. Other ranges are also possible.

In an embodiment, the sand composition may further optionally include a surfactant. In a preferred embodiment, the surfactant may be a nonionic surfactant, an anionic surfactant, a cationic surfactant, a viscoelastic surfactant, or a zwitterionic surfactant. The surfactants may include, but are not limited to, ammonium lauryl sulfate, sodium lauryl sulfate (SLS), sodium dodecyl sulfate (SDS), alkyl-ether sulfates sodium laureth sulfate (sodium lauryl ether sulfate (SLES), sodium myreth sulfate, docusate (dioctyl sodium sulfosuccinate), perfluorooctanesulfonate (PFOS), perfluorobutanesulfonate, alkyl-aryl ether phosphates, alkyl ether phosphates, octenidine dihydrochloride; cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), CHAPS (3-[(3-cholamidopropyl)dimethylammonio]-1-propanesulfonate), cocamidopropyl hydroxysultaine, ocamidopropyl betaine, phospholipids, and sphingomyelins. In a preferred embodiment, the sand composition has a weight percentage of the surfactant ranging from 0.1-3.0% relative to the total weight of the composition, preferably 0.2-2.5%, preferably 0.5-2.0%, preferably 1.0-1.8%, preferably 1.2-1.6%, or about 1.5% relative to the total weight of the sand composition. Other ranges are also possible.

The surfactant may include primary and secondary emulsifiers. Hereinafter, the primary and secondary emulsifiers are collectively referred to as the “emulsifiers” or “surfactants” and individually referred to as the “emulsifier” or “surfactant,” unless otherwise specified. The primary emulsifier is a polyaminated fatty acid. The primary emulsifier includes a lower hydrophilic-lyophilic balance (HLB) in comparison to the secondary emulsifier. The primary emulsifier may include, but are not limited to, span 60, span 85, span 65, span 40, and span 20. The primary emulsifier is sorbitan oleate, also referred to as the span 80. The secondary emulsifier may include, but are not limited to triton X-100, Tween™ 80, Tween™ 20, Tween™ 40, Tween™ 60, Tween™ 85, OP4 and OP 7. The secondary emulsifier includes a biosurfactant such as a rhamnolipid surfactant. In an embodiment, the surfactant may be neopelex or stearic acid.

The sand composition may further optionally include a defoaming agent. As used herein, the term “deforming agent” refers to the chemical additive that reduces and hinders foam formation in industrial process liquids. The deforming agent may include, but are not limited to, 2-octanol, oleic acid, paraffinic waxes, amide waxes, sulfonated oils, organic phosphates, silicone oils, mineral oils, and dimethylpolysiloxane. The defoaming agent may be dimethyl silicone polymer or polyoxy propylene glycerin ether. In a preferred embodiment, the sand composition has a weight percentage of the defoaming agent ranging from 0.01-1.0% relative to the total weight of the composition, preferably 0.02-0.8%, preferably 0.03-0.6%, preferably 0.04-0.4%, preferably 0.05-0.2%, or about 0.1% relative to the total weight of the sand composition.

In some embodiments, a cured specimen made from the sand composition has a compressive strength of 10-40 megapascal (MPa), preferably 11-39, preferably 12-38, preferably 13-37, preferably 14-36, preferably 15-35, preferably 16-34, preferably 17-33, preferably 18-32, preferably 19-31, preferably 20-30, preferably 21-29, preferably 22-28, preferably 22-27, and preferably 24-26 MPa. Other ranges are also possible.

In some preferred embodiments, a cured specimen made from the sand composition has a compressive strength of 25-35 MPa, preferably 26-34, preferably 27-33, preferably 28-32, and preferably 29-31 MPa. Other ranges are also possible.

In some embodiments, the compressive strength of the cured specimen is 10-90%, preferably 15-85, preferably 20-80, preferably 25-75, preferably 30-70, preferably 35-65, preferably 40-60, preferably 45-55% greater than the compressive strength of a cured specimen made from a class G cement slurry. Other ranges are also possible.

In some preferred embodiments, the compressive strength of the cured specimen is 50-90%, preferably 51-89%, preferably 52-88%, preferably 53-87%, preferably 54-86%, preferably 55-85%, preferably 56-84%, preferably 57-83%, preferably 58-82%, preferably 59-81%, preferably 60-80%, preferably 61-79%, preferably 62-78%, preferably 63-77%, preferably 64-76%, preferably 65-75%, preferably 66-74%, preferably 67-73%, preferably 68-72%, preferably 69-71%, greater than the compressive strength of the cured specimen made from the class G cement slurry. Other ranges are also possible.

In some embodiments, the carbonate sand is in the form of irregular shaped calcium carbonate particles. In some further embodiments, the carbonate sand may also be in the form of angular, and flake-like particles. In some embodiments, the carbonate sand has a cumulative 10% particle size (D₁₀) of 0.6 to 1.2 micrometers (μm), preferably 0.7 to 1.1 μm, preferably 0.8 to 1.0 μm, or even more preferably about 0.9 μm. Other ranges are also possible. In some preferred embodiments, the carbonate sand has a median particle size (D₅₀) of 3 to 4.2 μm, preferably 3.2 to 4.0 μm, preferably 3.4 to 3.8 μm, or even more preferably about 3.6 μm. Other ranges are also possible. In some most preferred embodiments, the carbonate sand has a cumulative 90% particle size (D₉₀) of 20 to 32 μm, preferably 22 to 30 μm, preferably 24 to 28 μm, or even more preferably about 26 μm. Other ranges are also possible.

As used herein, the term “flake,” “flake-like,” or “flake-like particle” generally refers to the shape or morphology of an object or substance that resembles flakes, similar to the shape of a flat, thin piece of the fragments or structures. In the present disclosure, the term flake-like refers to a particle that has a thin and elongated shape similar to a flake that has an aspect ratio in a range of 20:1 to 1:20, preferably 15:1 to 1:5, preferably 10:1 to 1, preferably 8:1 to 2:1, or even more preferably 6:1 to 4:1. Other ranges are also possible.

In some embodiments, the carbonate sand is in the form of irregular shaped calcium carbonate particles having a D₁₀ particle size of about 0.9 μm, a D₅₀ particle size of about 3.6 μm, and a D₉₀ particle size of about 26 μm. Other ranges are also possible.

In some embodiments, the quartz sand is in the form of irregular shaped silica particles. In some further embodiments, the quartz sand may also be in the form of angular, and flake-like particles. In some embodiments, the quartz sand has a D₁₀ particle size of 1.1 to 1.7 μm, preferably 1.2 to 1.6 μm, preferably 1.3 to 1.5 μm, or even more preferably about 1.4 μm. Other ranges are also possible. In some preferred embodiments, the quartz sand has a D₅₀ particle size of 8.7 to 9.9 μm, preferably 8.9 to 9.7 μm, preferably 9.1 to 9.5 μm, or even more preferably about 9.3 μm. Other ranges are also possible. In some most preferred embodiments, the quartz sand has a D₉₀ particle size of 24.7 to 36.7 μm, preferably 26.7 to 34.7 μm, preferably 28.7 to 32.7 μm, or even more preferably about 30.7 μm. Other ranges are also possible.

In some embodiments, the quartz sand is in the form of irregular shaped silica particles. In some embodiments, the quartz sand has a D₁₀ particle size of about 1.4 μm, a D₅₀ particle size of about 9.3 μm, and a D₉₀ particle size of about 30.7 μm. Other ranges are also possible.

The crystalline structure of the Red Sea sand, quartz sand, cold-sintered Red Sea powder (R100), and cold-sintered Red Sea powder (70 wt. %) mixed with quartz powder (30 wt. %) (R70) is characterized by X-ray diffraction (XRD). In some embodiments, the XRD patterns are collected in a PANalytical Empyrean diffractometer equipped with a Cu-Kα radiation source (λ−1.5406 Å) for a 2θ range extending between 4 and 70°. Other ranges are also possible.

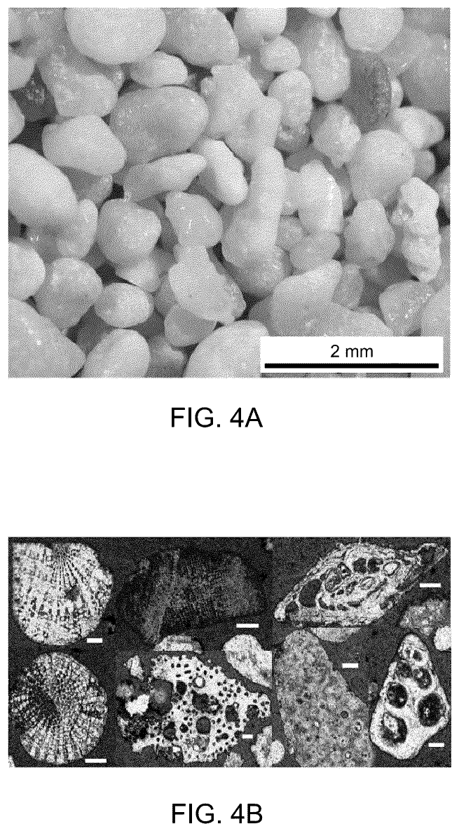

In some embodiments, the Red Sea sand has peaks with a 2θ value of about 25 to 26.5°, about 26.5 to 27°, about 29 to 30.5°, about 30.5 to 31.5°, about 32.5 to 33.5°, about 35.5 to 36.5°, about 36.5 to 39°, about 39 to 40°, about 40.5 to 41.5°, and 42.5 to 44.5° in the XRD spectrum, as depicted in FIG. 3. Other ranges are also possible.

In some embodiments, the quartz sand has peaks with a 2θ value of about 19 to 21°, about 25.5 to 27.5°, about 36 to 37°, about 39 to 41°, and 42 to 44° in the XRD spectrum, as depicted in FIG. 3. Other ranges are also possible.

In some embodiments, the cold-sintered Red Sea powder (R100) has peaks with a 2θ value of about 25 to 26.5°, about 26.5 to 27°, about 29 to 30.5°, about 30.5 to 31.5°, about 32.5 to 33.5°, about 35.5 to 36.5°, about 36.5 to 39°, about 39 to 40°, about 40.5 to 41.5°, and 42.5 to 44.5° in the XRD spectrum, as depicted in FIG. 3. Other ranges are also possible.

In some embodiments, the cold-sintered Red Sea powder (70 wt. %) mixed with quartz powder (30 wt. %) (R70) has peaks with a 2θ value of about 19 to 21°, about 25 to 26.5°, about 26.5 to 27.5°, about 29 to 30.5°, about 30.5 to 31.5°, about 32.5 to 33.5°, about 35.5 to 36.5°, about 36.5 to 39°, about 39 to 40°, about 40.5 to 41.5°, and 42.5 to 44.5° in the XRD spectrum, as depicted in FIG. 3. Other ranges are also possible.

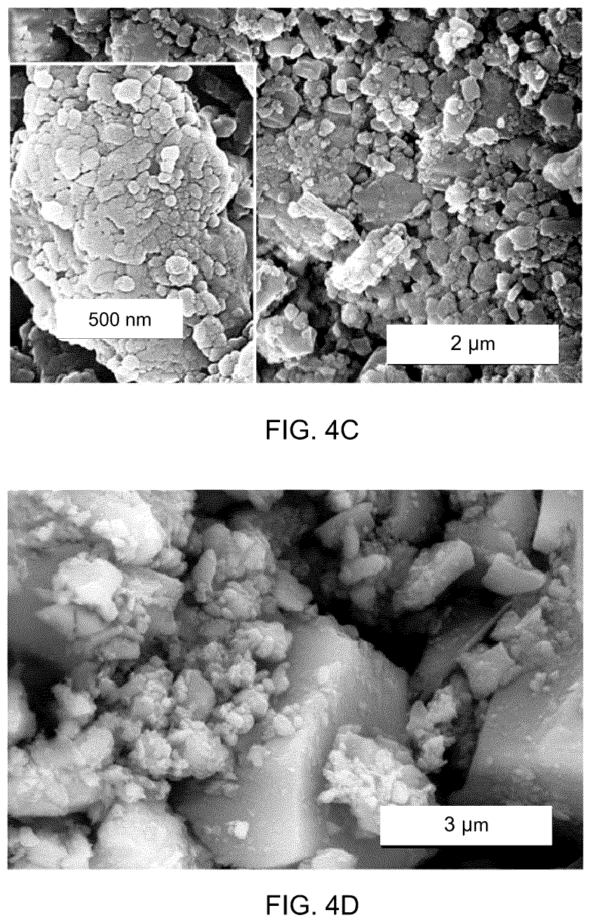

A photomicrograph of the Red Sea beach sand may be taken under a LEICA S9i stereomicroscope as depicted in FIG. 4A. The Red Sea beach sand before milling contains oval-shaped particles having an average particle size measured at its longest dimension in a range of 0.5 to 2 mm, preferably 0.8 to 1.6 mm, preferably 1 to 1.2 mm, or even more preferably about 1 mm. Other ranges are also possible.

A photomicrograph of a thin section of the Red Sea beach sands may be taken under a polarizing microscope, e.g., an Olympus EX51 microscope, as depicted in FIG. 4B. In some embodiments, the thin section of the Red Sea beach sands contains coral reef debris, including but not limited to corals, echinoderm fragments/spines, gastropods, and foraminifera.

Scanning electron microscopic (SEM) photomicrographs of cold-sintered Red Sea powder, and cold-sintered Red Sea powder mixed with quartz powder may be collected on a scanning electron microscope. e.g., a FEI Helios Nanolab G3 UC microscope. In some embodiments, the cold-sintered Red Sea powder as depicted in FIG. 4C contains irregular shaped calcium carbonate particles. In some embodiments, the irregular shaped calcium carbonate particles are bounded together with a preferred orientation resulting in the formation of aggregates. In some further embodiments, the irregular shaped calcium carbonate particles are bounded together in a disordered orientation. In some embodiments, the aggregates of calcium carbonate particles may be a polygon shape or a round shape. Other shapes are also possible.

In some embodiments, the cold-sintered Red Sea powder mixed with quartz powder as depicted in FIG. 4D contains irregular shaped calcium carbonate particles and irregular shaped silica particles. In some further embodiments, the irregular shaped calcium carbonate particles and irregular shaped silica particles are bounded together with a preferred orientation resulting in the formation of aggregates. In some further embodiments, the irregular shaped calcium carbonate particles and irregular shaped silica particles are bounded together in a disordered orientation. In some preferred embodiments, the aggregates of calcium carbonate and silica particles may be a polygon shape. Other shapes are also possible.

Shape of the aggregates of the present disclosure may be cubical and reasonably regular, essentially rounded, angular, or irregular. Surface texture may range from relatively smooth with small, exposed pores to irregular with small to large exposed pores. Particle shape and surface texture of both Red Sea powder aggregates and Red Sea powder/quartz powder aggregates may influence proportioning of mixtures in such factors as workability, pumpability, aggregate ratio, and water requirement.

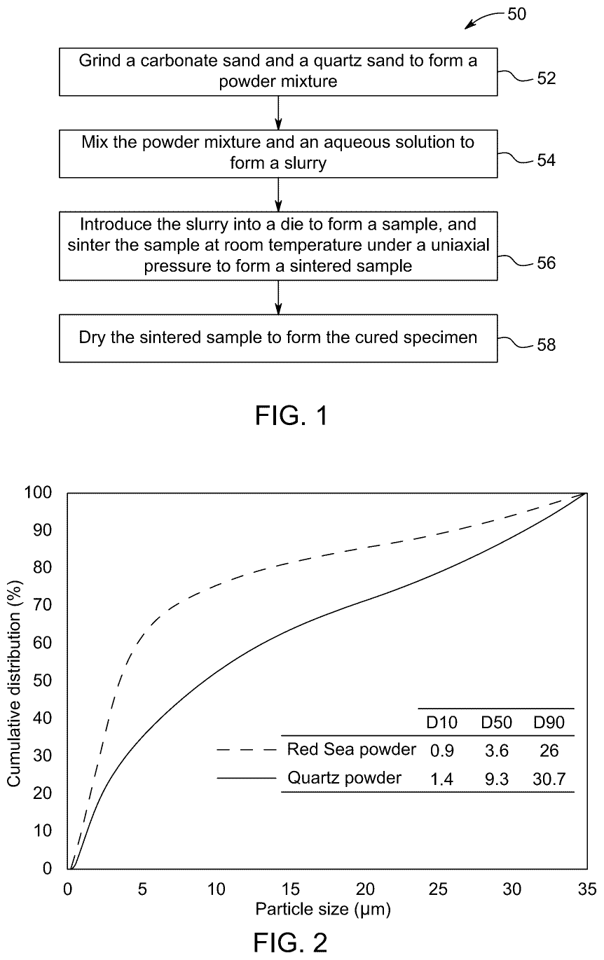

FIG. 1 illustrates a flow chart of a method 50 of making a cured specimen including the sand composition. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes grinding the carbonate sand and the quartz sand to form a powder mixture. The grinding may be carried out using any suitable means, for example, ball milling, blending, etc., using manual method 100 s (e.g., mortar) or machine-assisted method 100 s such as using a mechanical blender, or any other apparatus known to those of ordinary skill in the art. In some embodiments, the carbonate sand after the grinding has a D₅₀ particle size of about 3.6 μm. In some embodiments, the quartz after grinding has a D₅₀ particle size of about 9.3 μm.

At step 54, the method 50 includes mixing the powder mixture and an aqueous solution to form a slurry. In some embodiments, the aqueous solution includes at least one inorganic salt selected from sodium salt, a potassium salt, a calcium salt, a magnesium salt, a lithium salt, and an aluminum salt. The inorganic salt includes a counter ion. Suitable examples of counter ion include halogen ion like fluoride ion, chloride ion, bromide ion, iodide ion, nitrogen-containing ion like nitrate ion, nitrite ion, sulfur containing ion like sulfate ion, sulfide ion, and sulfite ion. In a preferred embodiment, the counter ion is a halogen ion. In a specific embodiment, the counter halogen ion is a chloride ion. In a specific embodiment, the inorganic salt is sodium chloride (NaCl). In some embodiments, at least one inorganic salt is present in the aqueous solution at a concentration of 0.5-2 wt. %, preferably 0.6-1.9 wt. %, preferably 0.7-1.8 wt. %, preferably 0.8-1.7 wt. %, preferably 0.9-1.6 wt. %, preferably 1.0-1.5 wt. %, preferably 1.1-1.4 wt. %, and preferably 1.2-1.3 wt. % based on the total weight of the aqueous solution. Other ranges are also possible. In a specific embodiment, the aqueous solution includes NaCl at a concentration of about 0.9 wt. %, based on the total weight of the aqueous solution. In some embodiments, the mixing may be carried out manually or with the help of a stirrer. In some embodiments, a weight ratio of the powder mixture and the aqueous solution is in a range of 1:1-7:1, preferably 2:1, preferably 3:1, preferably 4:1, preferably 5:1, preferably 6:1, and preferably 7:1. Other ranges are also possible. In a specific embodiment, the weight ratio of the powder mixture and the aqueous solution is about 5:1. Other ranges are also possible.

In some embodiments, the water present in the aqueous solution may be tap water, distilled water, bi-distilled water, de-ionized water, de-ionized distilled water, reverse osmosis water, and/or some other water. In one embodiment, the water is bi-distilled to eliminate trace metals. Preferably the water is bi-distilled, de-ionized, deionized di-stilled, or reverse osmosis water and at 25° C.

At step 56, the method 50 includes introducing the slurry into a die to form a sample and sintering the sample at room temperature under a uniaxial pressure to form a sintered sample. In some embodiments, the sintering of the sample is performed under the uniaxial pressure of 200-400 MPa, preferably 210-390, preferably 220-380, preferably 230-370, preferably 240-360, preferably 250-350, preferably 260-340, preferably 270-330, preferably 280-320, and preferably 290-310 MPa for 10-60 minutes (min), preferably 15-55, preferably 20-50, preferably 25-45, and preferably 30-40 min. Other ranges are also possible. In a specific embodiment, the sintering of the sample is performed under the uniaxial pressure of 300 MPa for 30 min. Other ranges are also possible.

As used herein, the term “room temperature” generally refers to a temperature in a range of 10 to 40° C., preferably 15 to 30° C., or even more preferably 20 to 25° C. Other ranges are also possible.

In some other embodiments, the sintering the sample is at least one selected from the group consisting of a spark plasma sintering (SPS), a heat press sintering, and a hybrid sintering. In some further embodiments, the sintering the sample may be performed at a temperature in a range of 40 to 500° C., preferably 50 to 400° C., preferably 60 to 300° C., preferably 70 to 200° C., preferably 80 to 100° C., or even more preferably about 90° C. Other ranges are also possible.

In some embodiments, the sample after the sintering contains less than 60%, preferably less than 50%, preferably less than 40%, preferably less than 30%, preferably less than 20%, preferably less than 10%, or even more preferably less than 5% of water present in the slurry. Other ranges are also possible.

In some embodiments, the carbonate sand includes calcium carbonate. Various polymorphic forms of calcium carbonate may exist. In some embodiments, the polymorphs of calcium carbonate include aragonite polymorph and calcite polymorph. Other polymorphs are also possible. In some embodiments, a ratio of the aragonite polymorph and the calcite polymorph present in the calcium carbonate is in a range of 3:2-4:1, preferably 4:2-3:1, and preferably 5:2-2:1. Other ranges are also possible. In some embodiments, a ratio of aragonite, calcite, and quartz remains unchanged after the sintering.

At step 58, the method 50 includes drying the sintered sample to form the cured specimen. In some embodiments, the drying of the sintered sample can be done by using heating appliances such as ovens, microwaves, autoclaves, hot plates, heating mantles and tapes, oil baths, salt baths, sand baths, air baths, hot-tube furnaces, and hot-air guns. In some further embodiments, the drying of the sintered sample is performed at a temperature of 60-100 degrees Celsius (° C.), preferably 61-99° C., preferably 62-98° C., preferably 63-97° C., preferably 64-96° C., preferably 65-95° C., preferably 66-94° C., preferably 67-93° C., preferably 68-92° C., preferably 69-91° C., preferably 70-90° C., preferably 71-89° C., preferably 72-88° C., preferably 73-87° C., preferably 74-86° C., preferably 75-85° C., preferably 76-84° C., preferably 77-83° C., preferably 78-82° C., preferably 79-81° C., for 1-12 hours (h), preferably 2-11 h, preferably 3-10 h, preferably 4-9 h, preferably 5-8 h, and preferably 6-7 h. Other ranges are also possible. In a specific embodiment, the drying of the sintered sample is performed at a temperature of about 80° C. for about 3 h. Other ranges are also possible.

The cured specimens are suitable for constructing various structural elements, such as roads, panels, buildings, beams, pavements, and street furniture.

The compressive strength of processed calcium carbonate powder from Red Sea coastal sands was examined, both in pure form and mixed with varying amounts of quartz powder, to prepare less pure carbonate beach sands. The samples containing, e.g., preferably about 70% or more calcium carbonate outperformed equal-sized reference cement samples. Pure calcium carbonate samples exhibited, e.g., preferably about 88.4% higher compressive strength than cement samples.

### EXAMPLES

The following examples demonstrate a sand composition as described herein. The examples are provided solely for illustration and are not to be construed as limitations of the present disclosure, as many variations thereof are possible without departing from the spirit and scope of the present disclosure.

### Example 1: Materials

A carbonate sand sample was collected from a beach on the central Saudi Arabian side of the Red Sea. The pure Red Sea carbonate beach sands were blended with varying amounts of quartz sand by systematically elevating the proportion of quartz from 0 to 50%, as depicted in Table 1. The pure quartz sand was collected from the Nafud desert, located in the northern region of the Arabian Peninsula.

TABLE 1
Composition of samples prepared for cold-sintering, expressed
as weight percentages of calcium carbonate (from Red Sea
Beach sand) and quartz (from Nafud desert sand) powders.

| Sample ID | Carbonate powder % | Quartz sand powder % |
|---|---|---|
| R100 | 100 | 0 |
| R90 | 90 | 10 |
| R70 | 70 | 30 |
| R60 | 60 | 40 |
| R50 | 50 | 50 |

### Example 2: Material Processing and Characterization

Both types of sand were ground to a powder using a steel vibratory disc mill for 10 minutes. A laser diffraction particle size analyzer (HELOS/R, Sympatec GmbH) was used to measure the particle size distribution of the powders. Following the preparation of powder samples, a sand composition containing both carbonate sand and quartz sand was blended with a 0.9 wt. % NaCl aqueous solution, at a water-to-powder ratio of 0.2 to form a slurry mixture. Next, the slurry mixture underwent cold sintering using an automatic hydraulic press machine (TMAX-ZYP, TMAXCN, China) in a 20 mm die at room temperature, applying a uniaxial pressure of 300 MPa for 30 minutes (min). Finally, the sintered samples were dried for three hours at about 80° C.

The compressive strength of cold-sintered samples was carried out using a Matest Cyber Plus compressive testing machine. The load was applied at a rate of 1.5 kN/sec. On average, the compressive strength values have a reproducibility of ±1.2 MPa. A reference material comprising class G cement slurry was prepared for this study. The slurry was made by mixing 300 grams of Class G cement with 133 grams of water and then curing it for one week at 50° C. X-ray diffraction (XRD) was utilized to identify and quantify the mineral phases in the samples before and after cold-sintering. Samples were ground in a mill (MM 400, Retsch) for 4 minutes. A PANalytical Empyrean diffractometer was used to record the XRD patterns at 45 kV and 40 mA, using CuK_{α} radiation. The samples were scanned from 4° to 70 ° 2θ with a 0.01° 2θ increment and a counting time of 40 seconds per increment. Powder diffraction patterns were analyzed using the Match software. The Red Sea sand was photographed using a LEICA S9i stereomicroscope. To identify the primary calcium carbonate components of the sand, a thin section of the hardened sample (which was injected with blue-dyed epoxy) was observed under a polarized microscope (Olympus EX51). A scanning electron microscope (SEM, FEI Helios Nanolab G3 UC) was used to observe the morphology of the cold-sintered powder.

### Example 3: Particle Size Analysis

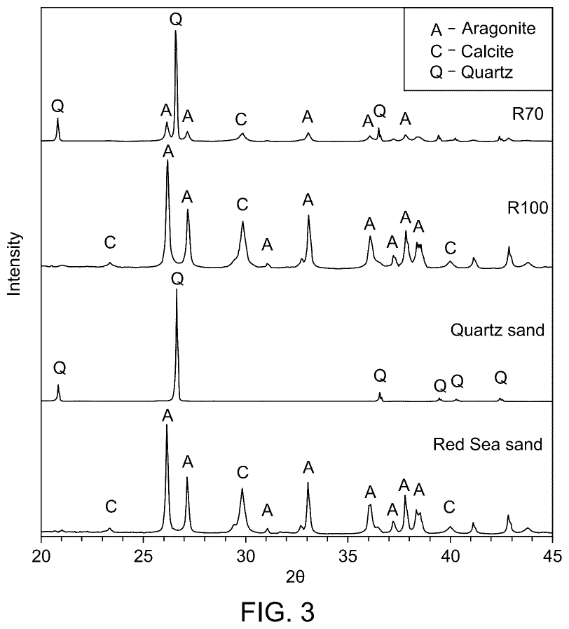

FIG. 2 shows the cumulative particle size distribution of the Red Sea beach sand and quartz sand after grinding. Particle sizes (in μm) at 10%, 50%, and 90% in the cumulative size distribution are denoted as D10, D50, and D90, respectively; while both powders have a wide range, the median size of Red Sea sand powder is smaller than that of quartz sand powder, with D50 values of 3.6 μm and 9.3 μm, respectively.

### Example 4: XRD Analysis

FIG. 3 shows the powder XRD patterns of the Red Sea beach sand, Nafud desert sand, cold-sintered sample (R100) of pure Red Sea powder, and cold-sintered sample (R70) of Red Sea powder (70%) mixed with quartz powder (30%). The Red Sea beach sand sample is composed entirely of calcium carbonate, with 73% aragonite [COD ID: 4001362] and 27% magnesian calcite [COD ID: 9001298]. On the other hand, the Nafud desert sand sample is made up entirely of quartz. The aragonite-to-calcite ratio of the cold-sintered powder of the Red Sea sand (sample R100) remains like the ratio before cold-sintering. Likewise, the ratio remains unchanged after cold sintering a mixture of carbonate powder (70%) and quartz powder (30%) (sample R70). This shows that aragonite, the least stable phase, remains unchanged during cold-sintering at room temperature. No new phases were detected in the cold-sintered samples, suggesting no reaction between quartz and carbonate phases.

### Example 5: Photomicrograph Analysis

FIG. 4A shows a reflected light stereo-photomicrograph of the raw Red Sea beach sands. Thin-section observation under plane-polarized-light microscopy reveals that the sand is composed predominantly of re-worked modern coral reef debris, including corals, echinoderm fragments/spines, along with the occurrence of gastropods and foraminifera (FIG. 4B). FIG. 4C and FIG. 4D show SEM photomicrographs of cold-sintered Red Sea powder (R100; FIG. 4C) and cold-sintered Red Sea powder after mixing with 50% quartz powder (R50; FIG. 4D). All cold-sintered specimens remained completely intact when extracted from the hydraulic press machine, except for the sample containing the highest proportion of quartz (R50), with only a minor portion of R50 adhering to the die. The obtained densified samples were cylindrical, measuring 20 mm in diameter and around 18 mm in height.

### Example 5: Compressive Strength

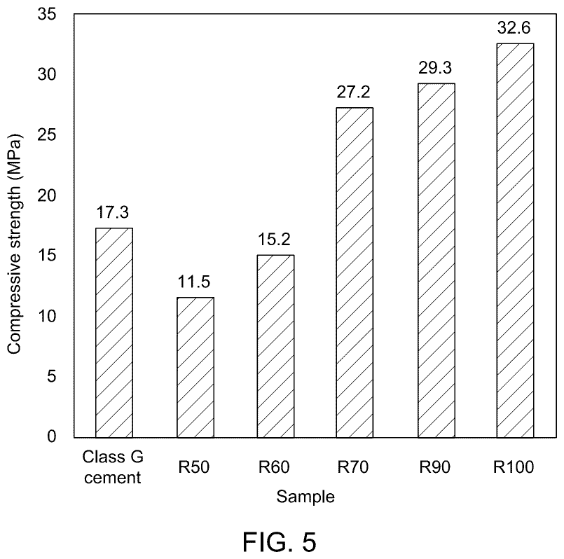

FIG. 5 shows the compressive strength values of cold-sintered Red Sea carbonate powder before (R100) and after mixing with Nafud quartz powder (R90-R50). Additionally, the compressive strength of class G cement, cured for one week at 50° C., is included for comparison. The pure calcium carbonate sample exhibits the highest compressive strength (32.6 MPa). The compressive strength of cold-sintered samples decreases as the quantity of quartz powder mixed with carbonate powder increases. The decline in compressive strength exhibits a gradual trend until impurities surpass 30%, at which point a notable reduction becomes evident. Samples containing carbonate phases with a 70% or higher content exhibit greater compressive strength than class G cement samples (17.3 MPa) with the same dimensions. Conversely, samples with a quartz content exceeding 30% demonstrate lower compressive strength values than the cement. Therefore, high-purity calcium carbonate sands in combination with water as a transient phase may improve the mechanical properties of the cured specimen.

Numerous modifications and variations of the present disclosure are possible in light of the above teachings. It is therefore to be understood that within the scope of the appended claims, the invention may be practiced otherwise than as specifically described herein.

1. A sand composition, including:
a carbonate sand present in an amount of 50 to 99.99% by weight based on a total weight of the sand composition;
a quartz sand in an amount of 0.01 to 50% by weight based on the total weight of the sand composition;
wherein a cured specimen made from the sand composition has a compressive strength of 10 to 40 megapascal (MPa), and wherein the compressive strength of the cured specimen is 10 to 90% greater than the compressive strength of a cured specimen made from a class G cement slurry.

2. The sand composition of claim 1, wherein:
the carbonate sand is present in an amount of 50 to 90% by weight based on the total weight of the sand composition;
the quartz sand is present in an amount of 10 to 50% by weight based on the total weight of the sand composition;
the cured specimen made from the sand composition has a compressive strength of 25 to 35 MPa, and the compressive strength of the cured specimen is 50 to 90% greater than the compressive strength of the cured specimen made from the class G cement slurry.

3. The sand composition of claim 1, wherein the carbonate sand is obtained from the Red Sea coast.

4. The sand composition of claim 1, wherein the carbonate sand is in the form of irregular shaped calcium carbonate particles having a cumulative 10% particle size (D₁₀) of about 0.9 micrometers (μm).

5. The sand composition of claim 1, wherein the carbonate sand is in the form of irregular shaped calcium carbonate particles having a median particle size (D₅₀) of about 3.6 μm.

6. The sand composition of claim 1, wherein the carbonate sand is in the form of irregular shaped calcium carbonate particles having a cumulative 90% particle size (D₉₀) of about 26 μm.

7. The sand composition of claim 1, wherein the quartz sand is obtained from the Nafud desert.

8. The sand composition of claim 1, wherein the quartz sand is in the form of irregular shaped silica particles having a D₁₀ particle size of about 1.4 μm.

9. The sand composition of claim 1, wherein the quartz sand is in the form of irregular shaped silica particles having a D₅₀ particle size of about 9.3 μm.

10. The sand composition of claim 1, wherein the quartz sand is in the form of irregular shaped silica particles having a D₉₀ particle size of about 30.7 μm.

11. The sand composition of claim 1, wherein the carbonate sand includes calcium carbonate, and wherein the calcium carbonate includes aragonite polymorph and calcite polymorph.

12. The sand composition of claim 11, wherein a ratio of the aragonite polymorph and the calcite polymorph is in a range of 3:2 to 4:1.

13. A method of making a cured specimen including the sand composition of claim 1, including:
grinding the carbonate sand and the quartz sand to form a powder mixture;
mixing the powder mixture and an aqueous solution to form a slurry;
introducing the slurry into a die to form a sample, and sintering the sample at room temperature under a uniaxial pressure to form a sintered sample;
wherein a ratio of aragonite, calcite, and quartz remains unchanged after the sintering; and
drying the sintered sample to form the cured specimen.

14. The method of claim 13, wherein the carbonate sand after the grinding has a D₅₀ particle size of about 3.6 μm, and wherein the quartz after the grinding has a D₅₀ particle size of about 9.3 μm.

15. The method of claim 13, wherein the aqueous solution includes at least one inorganic salt selected from the group consisting of a sodium salt, a potassium salt, a calcium salt, a magnesium salt, a lithium salt, and an aluminum salt; and wherein the at least one inorganic salt includes a halogen counterion.

16. The method of claim 15, wherein the at least one inorganic salt is present in the aqueous solution at a concentration of 0.5 to 2 wt. % based on a total weight of the aqueous solution.

17. The method of claim 13, wherein a weight ratio of the powder mixture and the aqueous solution is about 5:1.

18. The method of claim 13, wherein the sintering the sample is performed under the uniaxial pressure of 200 to 400 MPa for 10 to 60 minutes.

19. The method of claim 13, wherein the drying the sintered sample is performed at a temperature of 60 to 100 degrees Celsius (° C.) for 1 to 12 hours.
